(19) United States
(12) Patent Application Publication
(10) Pub. No.: US 2009/0015578 A1
(43) Pub. Date: Jan. 15, 2009

(54) LIGHT EMITTING DISPLAY DEVICES

(75) Inventors: David A. Fish, Haywards Heath (GB); John R. Hughes, Horley (GB)

Correspondence Address: Venable LLP;Raymond J. Ho, 575 7th Street NW, Washington, DC, 20004-1601, US

(73) Assignee: KONINKLIJKE PHILIPS ELECTRONIC, N.V., EINDHOVEN (NL)

(21) Appl. No.: 10/596,866

(22) PCT Filed: Jan. 4, 2005
(86) PCT No.: PCT/IB2005/050026

§ 371 Date: Jun. 28, 2006

(30) Foreign Application Priority Data
Jan. 7, 2004 (GB) 0400209.3

(51) Int. Cl. G06F 3/038

(52) U.S. Cl. 345/212

(57) ABSTRACT

An active matrix electroluminescent display device has power supply lines (26) in the column direction. An isolating transistor (30) is provided for isolating a drive transistor (22) of each pixel from the pixel display element (2). The device is operable in two modes. In a first mode, the isolating transistor (30) isolates the drive transistor (22) from the display element (2) for each pixel, and pixel drive signals are provided to all pixels of the array in a row-by-row sequence. In a second mode, the isolating transistor couples the drive transistor to the display element and current is driven through the display elements. In this display device, pixel drive signals are loaded into the display array in one phase, in a row by row manner. As the power supply lines are in columns, during loading of the pixel drive signals, a current is provided to only one pixel along the power supply line at a time. No current is drawn by any display elements during this time, so that vertical cross talk is avoided. This enables pixel data to be stored accurately on the pixels.

This invention relates to light emitting display devices, for example electroluminescent displays, particularly active matrix display devices.

Matrix display devices employing electroluminescent, light-emitting, display elements are well known. The display elements may comprise organic thin film electroluminescent elements, for example using polymer materials, or else light emitting diodes (LEDs) using traditional III-V semiconductor compounds. Recent developments in organic electroluminescent materials, particularly polymer materials, have demonstrated their ability to be used practically for video display devices. These polymer materials typically comprise one or more layers of a semiconducting conjugated polymer sandwiched between a pair of electrodes, one of which is transparent and the other of which is of a material suitable for injecting holes or electrons into the polymer layer.

The polymer material can be fabricated using a CVD process, or a spin coating technique using a solution of a soluble conjugated polymer. Ink-jet printing may also be used. Organic electroluminescent materials exhibit diode-like I-V properties, so that they are capable of providing both a display function and a switching function, and can therefore be used in passive type displays. Alternatively, these materials may be used for active matrix display devices, with each pixel comprising a display element and a switching device for controlling the current through the display element.

Display devices of this type have current-driven display elements, so that a conventional, analogue drive scheme involves supplying a controllable current to the display element. It is known to provide a current source transistor as part of the pixel configuration, with the gate voltage supplied to the current source transistor determining the current through the display element. A storage capacitor holds the gate voltage after the addressing phase.

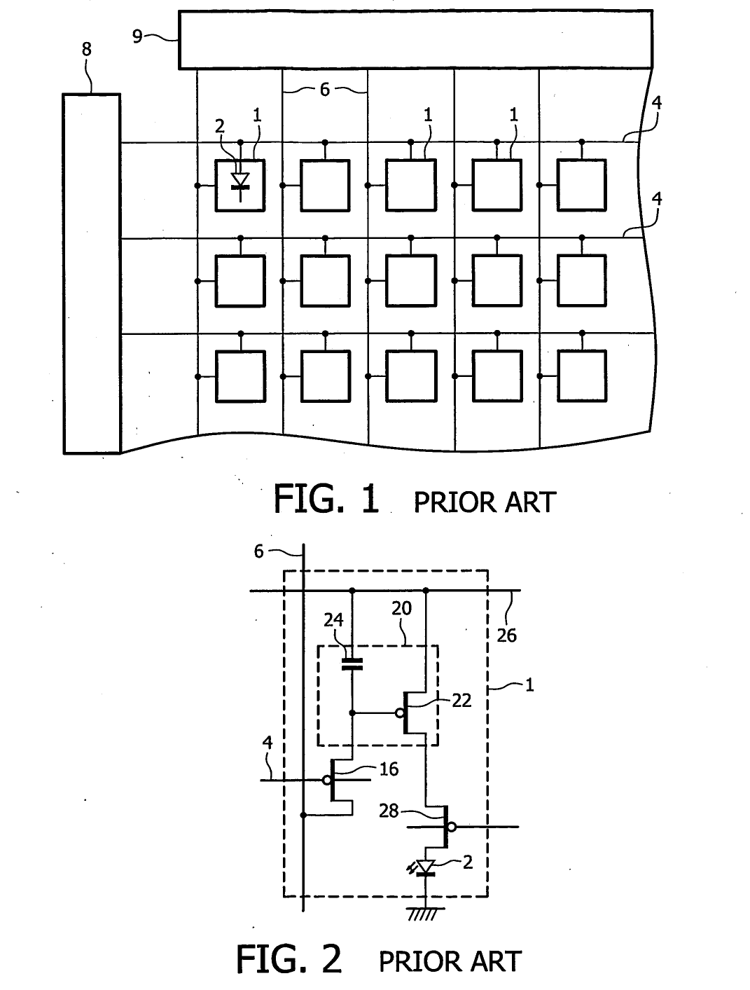

FIG. 1 shows a known active matrix addressed electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) address conductors 4 and 6. Only a few pixels are shown in the Figure for simplicity. In practice, there may be several hundred rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on one side of an insulating support. Either the cathodes or the anodes of the display elements are formed of transparent conductive material. The support is of transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support.

FIG. 2 shows in simplified schematic form a known pixel circuitry arrangement for providing voltage-programmed operation. Each pixel 1 comprises the EL display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended. The drive transistor 22 draws a current from the power supply line 26.

The drive transistor 22 in this circuit is implemented as a p-type TFT, so that the storage capacitor 24 holds the gate-source voltage fixed. This results in a fixed source-drain current through the transistor, which therefore provides the desired current source operation of the pixel.

The invention is concerned particularly with pixel configurations in which the power supply lines 26 are parallel to the column conductors 6, for example formed from the same metal layer. This metal layer is typically the top metal of the fabrication process, which can be thicker and therefore less resistive than the bottom metal layer usually used for forming the row conductors. The length of the power line is also then shorter for landscape displays, so that the voltage drops along the line will be lower, enabling larger displays to be fabricated.

If the pixel circuit of FIG. 2 is modified to use vertical power lines, it will suffer severe cross-talk. In particular, the pixel operates by shutting off current supply to the display element while the data is stored in the pixel, and the data voltage stored is a voltage which is relative to the power supply line voltage. The shut off is carried out by the additional transistor 28 in the circuit of FIG. 2, although other measures may be employed. For example, it has been proposed for the cathode voltage or the power supply line voltage to be switchable. As a result of the vertical power lines, the data voltage will be corrupted by power supply line voltage drops caused by other pixels in the column which are sill drawing current along the resistive power line. This is seen visually as vertical cross talk.

Current mirror circuits do not suffer this drawback, as the power supply to the pixel can be continuous and does not need to be interrupted. For this reason, current mirror circuits are typically used for implementing pixel configurations with vertical power supply lines. These are current-addressed pixel circuits rather than voltage-addressed pixel circuits.

However, the driver circuitry and drive scheme is simpler for voltage-addressed pixels than for current-addressed pixels, and there remains a need to solve the problem of vertical cross talk in a simple manner for voltage-addressed pixels using vertical power lines.

According to the invention, there is provided an active matrix electroluminescent display device comprising an array of display pixels arranged in rows and columns, each pixel comprising:
an electroluminescent (EL) display element;
a drive transistor for driving a current from an associated power supply line through the display element, each power line providing power to a respective column of display pixels;
an address transistor for providing a pixel drive signal from a data line to the gate of the drive transistor; and
an isolating transistor for isolating the drive transistor from the display element,
wherein the device is operable in two modes, a first mode in which the isolating transistor isolates the drive transistor from the display element for each pixel, and pixel drive signals are provided to all pixels of the array in a row-by-row sequence, and a second mode in which the isolating transistor couples the drive transistor to the display element and current is driven through the display elements.

In this display device, pixel drive signals are loaded into the display array in one phase, in a row by row manner. As the power supply lines are in columns, during loading of the pixel drive signals, a current is provided to only one pixel along the power supply line at a time. No current is drawn by any display elements during this time, so that vertical cross talk is avoided. This enables pixel data to be stored accurately on the pixels.

The EL display element and the drive transistor are preferably connected in series between first and second power lines.

The isolating transistor is preferably connected between the display element and the drive transistor.

Each pixel may further comprise a storage capacitor between the gate and source of the drive transistor. In this case, each pixel may further comprise a light-dependent device for discharging the storage capacitor in dependence on the light output of the display element.

This optical feedback arrangement provides compensation for ageing of the display element characteristics. However, this also requires higher peak (initial) currents to be drawn by the display elements.

To overcome the higher initial peak current, in the second mode, the isolating transistors for different rows of pixels can be turned on to couple the drive transistors to the display elements for rows of pixels in sequence. This enables the initial driving of pixels to be staggered, so that any column of pixels (sharing a power supply line) has only one pixel drawing the peak initial current, and the total current drawn from the power supply always approximates to an average value.

The invention also provides a method of addressing the pixels of an active matrix electroluminescent display device, comprising an array of rows and columns of display pixels, each comprising an electroluminescent (EL) display element and a drive transistor for driving a current through the display element, the method comprising:

in a first mode, isolating the drive transistor from the display element in each pixel, and providing pixel drive signals to all pixels of the array in a row-by-row sequence; and

in a second mode, coupling the drive transistor to the display element in each pixel and driving current through the display elements by drawing current from a column power supply line through the drive transistor and the display element.

This method provides operation of a pixel circuit with column power supply lines which eliminates vertical cross talk.

In the second mode, the drive transistors can be coupled to the display elements for rows of pixels in sequence. This is particularly suitable for an optical feedback pixel, in which part of the light output from the display element is used to control operation of the drive transistor. This drive scheme requires higher initial pixel drive currents, and by coupling the drive transistors to the display elements for rows of pixels in sequence, these initial peak currents are staggered.

Examples of the invention will now be described in detail with reference to the accompanying drawings, in which:

FIG. 1 shows a conventional active matrix LED display;

FIG. 2 shows a first known pixel layout for the display of FIG. 1;

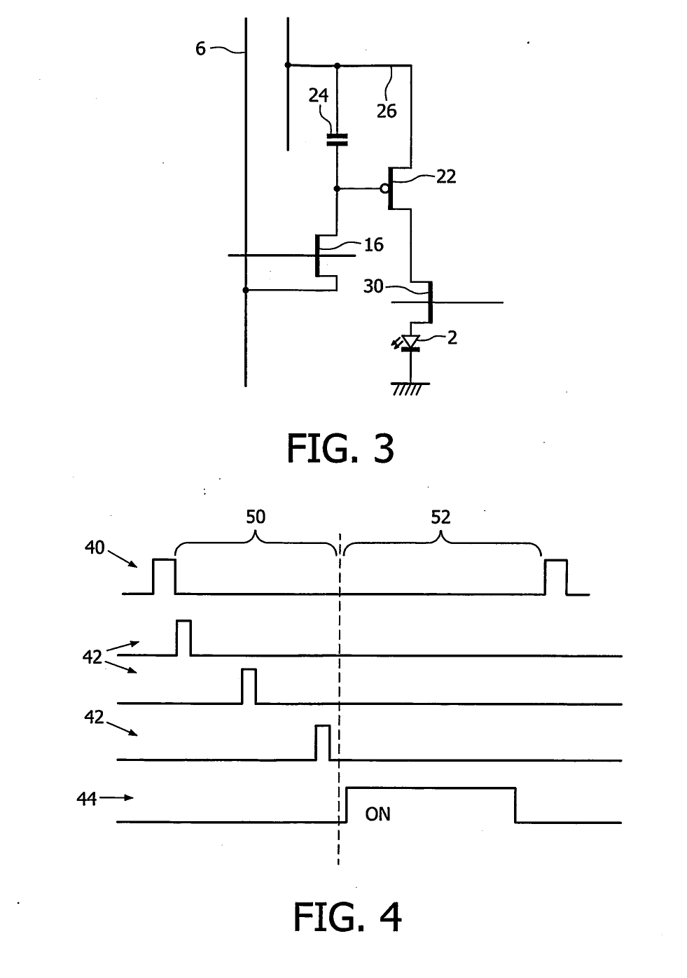

FIG. 3 shows a first pixel layout of the invention;

FIG. 4 shows a timing diagram for operation of the pixel layout of FIG. 3;

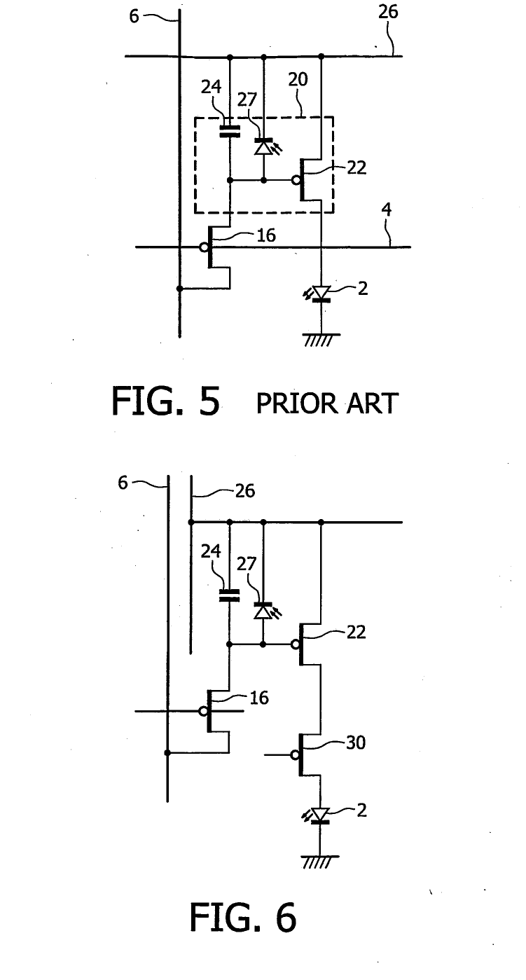

FIG. 5 shows a known optical feedback pixel layout;

FIG. 6 shows how the pixel layout of FIG. 5 is modified in accordance with the invention;

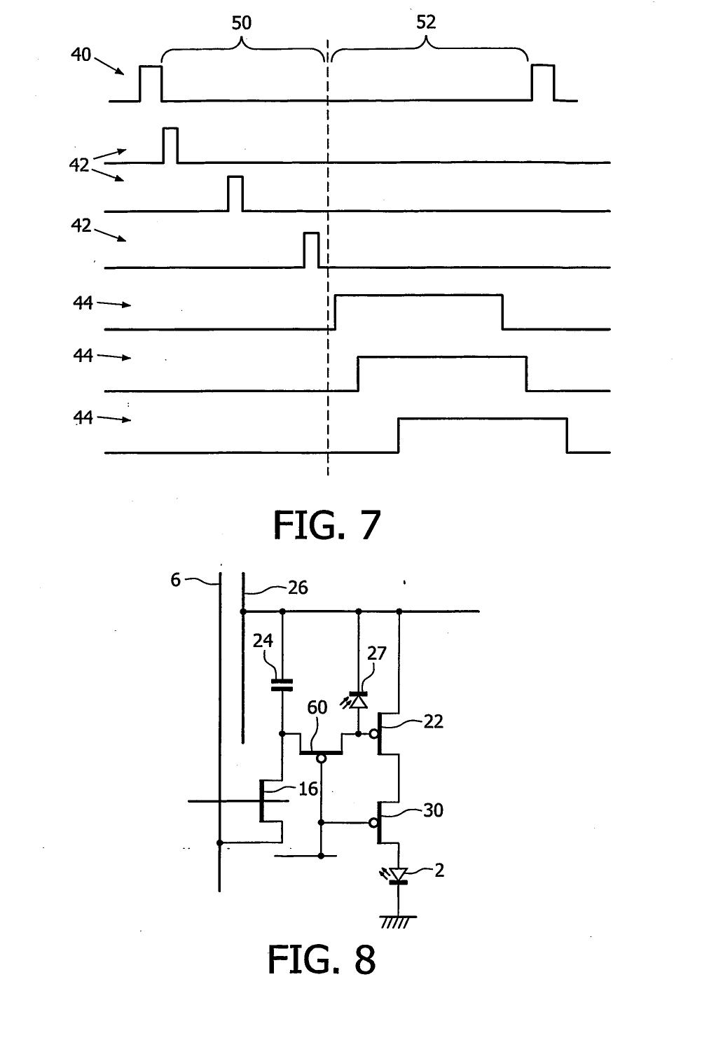

FIG. 7 shows a timing diagram for operation of the pixel layout of FIG. 6; and

FIG. 8 shows a modification to the pixel layout of the invention.

The invention provides an active matrix electroluminescent display device having column power supply lines and in which the drive transistor of each pixel is isolated from the display element during pixel programming. Pixel programming is carried out for all pixels, row-by-row, before any display pixels are driven. As the power supply lines are in columns and pixel programming is row-by-row, during pixel programming a current is provided to only one pixel along the power supply line at a time. No current is drawn by any display elements during this time, so that vertical cross talk is avoided.

FIG. 3 shows a pixel arrangement of the invention. The same components as appearing in FIG. 2 are given the same reference numbers. As shown, each power line 26 provides power to a respective column of display pixels. An isolating transistor 30 is provided between the drive transistor 22 and the display element 2 for isolating the drive transistor from the display element.

The pixel is operable in two modes, and these are explained with reference to FIG. 4, which is a timing diagram of the operation of the pixel circuit of FIG. 3.

Plot 40 shows the field pulse, which separates the addressing of sequential frames of image data. Plots 42 show row address pulses, which are used to switch on the address transistors 16 for complete rows of pixels. A pulse represents an ON condition of the address transistor. FIG. 4 shows the row address pulses for three rows, but of course all rows are addressed in sequence within the field period. Plot 44 shows the timing of operation of the isolation transistor 30.

A first mode 50 is a pixel programming mode. The isolating transistor 30 isolates the drive transistor 22 from the display element 2 for each pixel, and pixel drive signals are provided to all pixels of the array in a row-by-row sequence. As the power supply lines 26 are in columns, during loading of the pixel drive signals, a current is provided to only one pixel along the power supply line at a time. No current is drawn by any display elements during this time as a result of the isolating transistor, so that vertical cross talk is avoided. This enables pixel data to be stored accurately on the pixels.

A second mode 52 is a pixel drive mode. The isolating transistor 30 couples the drive transistor 22 to the display element 2 and current is driven through the display elements 2.

In the drive scheme of FIG. 4, all of the pixels are driven at the same time

There have been proposals for voltage-addressed pixel circuits which compensate for the aging of the LED material. For example, various pixel circuits have been proposed in which the pixels include a light sensing element. This element is responsive to the light output of the display element and acts to leak stored charge on the storage capacitor in response to the light output, so as to control the integrated light output of the display during the address period. FIG. 5 shows one example of known pixel layout for this purpose. Examples of this type of pixel configuration are described in detail in WO 01/20591 and EP 1 096 466.

In the pixel circuit of FIG. 5, a photodiode 27 discharges the gate voltage stored on the capacitor 24. The EL display element 2 will no longer emit when the gate voltage on the drive transistor 22 reaches the threshold voltage, and the storage capacitor 24 will then stop discharging. The rate at which charge is leaked from the photodiode 27 is a function of the display element output, so that the photodiode 27 functions as a light-sensitive feedback device. It can be shown that the integrated light output, taking into the account the effect of the photodiode 27, is given by:

$${L}_{T} = \frac{{C}_{S}}{{η}_{PD}} ( V ( 0 ) - {V}_{T} ) \qquad [ 1 ]$$

In this equation, ρ_{PD} is the efficiency of the photodiode, which is very uniform across the display, Cs is the storage capacitance, V(0) is the initial gate-source voltage of the drive transistor and V_{T} is the threshold voltage of the drive transistor. The light output is therefore independent of the EL display element efficiency and thereby provides aging compensation. V_{T} does vary across the display, and various other techniques have been proposed for compensating for these threshold voltage variations.

As the light output decays in this circuit, high initial currents are required to achieve high initial brightness, which is then reduced by the optical feedback system to provide the desired average light output. This means that very large currents will flow along the power rows at the beginning of the pixel driving phase in the circuit of FIG. 5, which worsens the problems described above of power line voltage drops.

In particular, the rows of pixels are conventionally addressed simultaneously, and in the conventional circuit of FIG. 5, these pixels all draw high large initial currents at the same time from the same row power supply line.

For this reason, the use of vertical power lines is particularly desirable for optical feedback circuits of the type explained with reference to FIG. 5. When using vertical power lines, and with row-by-row addressing of the pixels, the pixels in different rows are at different stages of the pixel drive cycle, so that the pixels along a column are not drawing the high initial currents simultaneously.

The invention can be applied to such optical feedback circuits, again in order to overcome the vertical cross talk problems associated with column power supply lines. The circuit of FIG. 5 is modified as shown in FIG. 6 in accordance with the invention.

As shown in FIG. 6, the isolation transistor 30 is again provided between the drive transistor 22 and the display element 2.

The drive scheme of FIG. 4 requires modification for implementation with an optical feedback pixel. In FIG. 4, the row-by-row driving of pixels is removed, and all pixels are driven simultaneously. Thus, at the beginning of the light emission phase 52, all pixels will initially be drawing the large currents. To overcome this problem, the light emission pulse 44 is staggered for different rows.

FIG. 7 shows a timing diagram for the operation of the circuit of FIG. 6 with this staggered light emission phase 52.

By staggering the starting the of time emission pulse 44 for the rows, the high initial currents drawn by the pixels in one row does not coincide with the high initial currents drawn by the pixels in another row. As a result, the total current drawn from the column power supply approximates to an average value of the pixel drive current.

This modification can be applied to all pixel designs and has benefits not only in the optical feedback implementation.

The drive scheme of the invention involves programming data into the pixels, followed by a short delay before the pixel drive phase. This delay is different for different rows, although less for the operation of FIG. 7. It is important to prevent leakage discharging the storage capacitor, and an additional transistor 60 can be used for this purpose, as shown in FIG. 8. As shown, the additional transistor can share the same control line as the isolating transistor.

This transistor stops leakage or dark currents in the photodiode from discharging the storage capacitor.

As mentioned above, compensation schemes have also been proposed for compensating for threshold voltage variations across the substrate. These schemes can be used to modify the pixel circuits and drive schemes described above. Different threshold voltage compensation schemes have been proposed for amorphous silicon and for polysilicon drive transistors. Amorphous silicon transistors suffer in particular from voltage stress-induced variations in threshold voltage, so that compensation is required over time. Polysilicon transistors, suffer in particular from variations in threshold voltage over the substrate, but these remain fairly constant over time, so that initial compensation is required.

The invention can be applied to pixel circuits using n-type or p-type drive transistors, using any transistor technology, and using any appropriate additional compensation schemes for threshold voltage or for other compensation factors.

Other modifications will be apparent to those skilled in the art.

1. An active matrix electroluminescent display device comprising an array of display pixels (1) arranged in rows and columns, each pixel comprising:
an electroluminescent (EL) display element (2);
a drive transistor (22) for driving a current from an associated power supply line (26) through the display element (2), each power line (26) providing power to a respective column of display pixels (1);
an address transistor (16) for providing a pixel drive signal from a data line to the gate of the drive transistor (22); and
an isolating transistor (30) for isolating the drive transistor from the display element,
wherein device is operable in two modes, a first mode (50) in which the isolating transistor (30) isolates the drive transistor (22) from the display element for each pixel, and pixel drive signals are provided to all pixels of the array in a row-by-row sequence, and a second mode (52) in which the isolating transistor couples the drive transistor (22) to the display element (2) and current is driven through the display elements.

2. A device as claimed in claim 1, wherein the EL display element and the drive transistor are connected in series between first (26) and second power lines.

3. A device as claimed in claim 2, wherein the isolating transistor (30) is connected between the display element (2) and the drive transistor (22).

4. A device as claimed in claim 1, wherein the drive transistor (22) is a polysilicon TFT.

5. A device as claimed in claim 1, wherein each pixel further comprises a storage capacitor (24) between the gate and source of the drive transistor (22).

6. A device as claimed in claim 5, wherein each pixel further comprises a light-dependent device (27) for discharging the storage capacitor (24) in dependence on the light output of the display element (2).

7. A device as claimed in claim 6, wherein the light dependent device (27) comprises a discharge photodiode.

8. A device as claimed in claim 1, wherein in the second mode, the isolating transistors (30) for different rows of pixels are turned on to couple the drive transistors (22) to the display elements (2) for rows of pixels in sequence.

9. A method of addressing the pixels of an active matrix electroluminescent display device, comprising an array of rows and columns of display pixels, each comprising an electroluminescent (EL) display element and a drive transistor for driving a current through the display element, the method comprising:
in a first mode (50), isolating the drive transistor (22) from the display element (2) in each pixel, and providing pixel drive signals to all pixels of the array in a row-by-row sequence; and
in a second mode (52), coupling the drive transistor (22) to the display element (2) in each pixel and driving current through the display elements by drawing current from a column power supply line (26) through the drive transistor and the display element.

10. A method as claimed in claim 9, wherein in the second mode, the drive transistors (22) are coupled to the display elements for rows of pixels in sequence.

11. A method as claimed in claim 10, wherein, in the second mode, part of the light output from the display element (2) is used to control operation of the drive transistor (22), thereby to implement an optical feedback control loop.

12. A method as claimed in claim 9, wherein isolating the drive transistor (22) from the display element (2) for a pixel comprises turning off an isolating transistor (30) between the display element (2) and the drive transistor of the pixel (22).
